(19) United States
(12) Patent Application Publication
(10) Pub. No.: US 2026/0200171 A1
(43) Pub. Date: Jul. 16, 2026

(54) APPARATUS AND METHOD FOR MAKING A STEREOLITHOGRAPHIC OBJECT

(71) Applicant: Zydex Pty. Ltd., Alexandria NSW (AU)

(72) Inventors: Stephan WEISS, Weida (DE); Justin ELSEY, Alexandria NSW (AU)

(21) Appl. No.: 19/130,368

(22) PCT Filed: Nov. 14, 2023
(86) PCT No.: PCT/AU2023/051153

§ 371 Date: May 15, 2025

(30) Foreign Application Priority Data
Nov. 15, 2022 (AU) 2022903432

(51) Int. Cl. B29C 64/286; B29C 64/124; B33Y 10/00; B33Y 30/00; G02B 5/02

(52) U.S. Cl. CPC B29C 64/286; B29C 64/124; B33Y 10/00; B33Y 30/00; G02B 5/021

(57) ABSTRACT

An apparatus for making a stereolithographic object. The apparatus includes a surface for disposing thereon a material used to make the stereolithographic object. The apparatus includes a platform for making the stereolithographic object thereon. The apparatus comprises a light source configured to generate a material hardening light for hardening the material. The apparatus includes an optical diffuser for diffusing the material hardening light and optically intermediate the light source and the surface.

### PRIORITY CLAIM

The present application is a National Phase entry of PCT Application No. PCT/AU2023/051153, filed Nov. 14, 2023, which claims the benefit of Australian Patent Application No. 2022903432, filed Nov. 15, 2022, which are incorporated herein by reference in their entirety.

### FIELD OF THE INVENTION

The present invention generally relates to an apparatus for making a stereolithographic object and a method for making a stereolithographic object.

### BACKGROUND OF THE INVENTION

A stereolithographic object (“object”) can be made one section at a time, that is layerwise, using an apparatus for making an object using a stereolithographic method. In a step of the stereolithographic method, a layer of a material used for making the object may be solidified in the shape of a section of the object. If the object comprises a plurality of sections, the step may be repeated until each of the plurality of sections are made.

In the context of this specification, a section is to be understood to encompass a slice of the stereolithographic object. A planar section encompasses a portion of the stereolithographic object located between two parallel planes that intersect the stereolithographic object. Generally, but not necessarily, the sections formed are planar sections.

The formation of object sections generally results in a stepped object surface. These steps result in surface texturing or roughness and may result in a frosted appearance to the naked eye. The steps are not desirable in all stereolithographic objects, examples of which include optics, objects that require cleaning or sterilization including but not limited to hearing aids and surgical instruments, and generally when a non-frosted surface aesthetic is desired.

It may be desirable to have improved apparatus for making an object.

### SUMMARY OF THE INVENTION

Disclosed herein is an apparatus for making a stereolithographic object. The apparatus comprises a surface for disposing thereon a material used to make a stereolithographic object. The apparatus comprises a platform for making the stereolithographic object thereon. The apparatus comprises a light source configured to generate a material hardening light for hardening the material. The apparatus comprises an optical diffuser for diffusing the material hardening light, the optical diffuser being optically intermediate the light source and the surface.

In an embodiment, the optical diffuser comprises an optical diffusing film.

In an embodiment, the optical diffuser comprises a polymer.

In an embodiment, the optical diffuser comprises at least one of a crystalline and a semi-crystalline polymer.

In an embodiment, the polymer comprises polytetrafluoroethylene (PTFE).

In an embodiment, the optical diffuser comprises polyethylene.

In an embodiment the optical diffuser comprises a holographic optical diffusing element.

In an embodiment the optical diffuser comprises a ceramic.

In an embodiment the optical diffuser comprises glass.

In an embodiment, the optical diffuser comprises a switchable optical diffuser.

An embodiment comprises an element comprising the surface and the optical diffuser.

In an embodiment, the element comprises a composite sheet comprising the surface and the optical diffuser.

In an embodiment, the optical diffuser is translucent.

In an embodiment, the optical diffuser has a thickness of 0.01 to 1 mm. The optical diffuser may have a thickness of 0.02 to 0.5 mm. The optical diffuser may have a thickness of 0.04 to 0.25 mm. The optical diffuser may have a thickness of 0.1 mm.

In an embodiment, the optical diffuser is for scattering the material hardening light such that at least one of 1%, 2%, 4%, 8%, 16%, 32% and 64% of the material hardening light is scattered.

In an embodiment, the optical diffuser is for scattering the material hardening light such that no more than one of 1%, 2%, 4%, 8%, 16%, 32% and 64% of the material hardening light is scattered.

In an embodiment, the optical diffuser is for scattering the material hardening light such that at least one of 1%, 2%, 4%, 8%, 16%, 32% and 64% of the material hardening light is scattered at an angle greater than 2.5 degrees.

In an embodiment, the optical diffuser is for scattering the material hardening light such that no more than one of 1%, 2%, 4%, 8%, 16%, 32% and 64% of the material hardening light is scattered at an angle greater than 2.5 degrees.

In an embodiment, the optical diffuser is for scattering the material hardening light such that at least one of 1%, 2%, 4%, 8%, 16%, 32% and 64% of the material hardening light is scattered at an angle less than 2.5 degrees.

In an embodiment, the optical diffuser is for scattering the material hardening light such that no more than at least one of 1%, 2%, 4%, 8%, 16%, 32% and 64% of the material hardening light is scattered at an angle less than 2.5 degrees.

In an embodiment, the optical diffuser is for generating granular free diffusion.

In an embodiment, the apparatus comprises a positioner operably coupled to at least one of the platform and the surface and operable to change a distance between the platform and the surface.

Disclosed herein is a method for making a stereolithographic object. The method comprises generating a material hardening light. The method comprises diffusing the material hardening light to generate a diffused material hardening light. The method comprises illuminating material used to make a stereolithographic object with the diffused material hardening light.

Disclosed herein is a method for making a stereolithographic object. The method comprises generating a material hardening light. The method comprises switching between a light diffusing mode and a light non-diffusing mode of a light diffuser having a plurality of modes. The method comprises illuminating a material used to make a stereolithographic object with the material hardening light that has propagated through the light diffuser.

In an embodiment, illuminating a material comprises illuminating a layer of the material with the material hardening light that has propagated through the light diffuser while in one of the light diffusing mode and the light non-diffusing mode, and subsequently illuminating the layer of the material with the material hardening light that has propagated through the light diffuser while in the other one of the light diffusing mode and the light non-diffusing mode.

An embodiment comprises electrically switching between the light diffusing mode and the light non-diffusing mode.

An embodiment comprises mechanically switching between the light diffusing mode and the light non-diffusing mode.

### BRIEF DESCRIPTION OF THE DRAWINGS

In order to achieve a better understanding of the nature of the present invention, embodiments will now be described, by way of example only, with reference to the accompanying figures in which:

FIGS. 1 to 4 show schematic elevation views of one embodiment of an apparatus for making a stereolithographic object during various stages of its use;

FIGS. 5 to 7 show schematic views of example radiation sources that may be part of the apparatus of FIG. 1;

FIG. 8 shows an example architecture of a controller for controlling the apparatus of FIG. 1;

FIG. 9 shows a schematic diagram of an example of an electrically switchable optical diffuser.

### DETAILED DESCRIPTION OF THE DRAWINGS

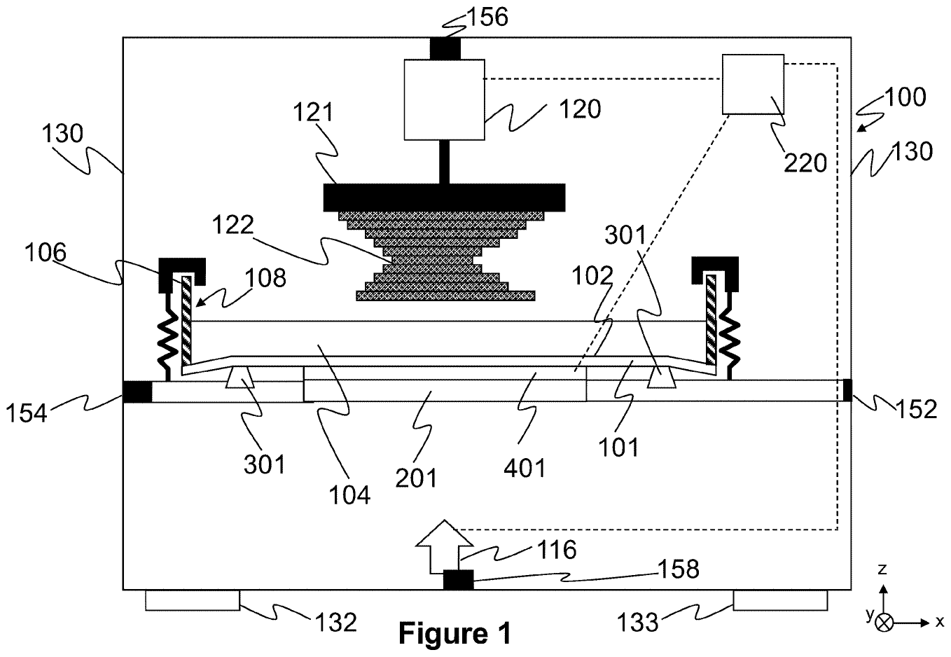

FIG. 1 shows a schematic diagram of an embodiment of an apparatus at which an object in the form of a stereolithographic object that can be made using the apparatus, the apparatus being generally indicated by the numeral 100. The apparatus 100 comprises a surface 102 for disposing thereon a material 104 used to make the stereolithographic object 122. The apparatus 100 comprises a platform 121 in the form of an inverted platform for making the stereolithographic object 122 thereon. The apparatus 100 comprises a positioner 120 operably coupled to at least one of the platform 121 and the surface 102 and operable to change a distance between the platform 121 and the surface 102. The apparatus 100 comprises a light source 116 configured to generate a material hardening light 118 for hardening the material when so disposed. The apparatus 100 comprises an optical diffuser 401 for diffusing the material hardening light 118. The optical diffuser 401 is optically intermediate the light source 116 and the surface 102. That is, the optical diffuser 401 is in the path of the light travelling between the light source 116 and the surface 102.

The effect of the optical diffuser 401 is to scatter some of the material hardening light 118, reducing the definition of the lateral boundary of the material hardening light 118 at the surface 102. This may generally reduce the degree of stepping of a surface of the stereolithographic object 122, and may generally improve the smoothness of the surface of the stereolithographic object 122.

The optical diffuser 401 is proximal to the surface 102 in the present embodiment. It may not necessarily be so, however, in all embodiments.

FIGS. 1 to 4 taken in sequence indicate one embodiment of a method for making the object 122. Coordinate axes are shown in the figures where x and y are optionally horizontally orientated and z is vertically orientated.

The apparatus 100 has a material receiving element 101 that is flexible and is in the form of a substantially transparent sheet over which a layer of the material 104 in the form of photohardenable liquid can be disposed. Any liquid used to make a stereolithographic object referred to in this specification may, as appropriate, be replaced with any suitable material or fluid used to make a stereolithographic object, and vice versa.

The element 101 may be inflexible in another embodiment. A photohardenable liquid (or photocurable liquid) is a liquid that hardens when exposed to a radiation such as visible or invisible light (ultraviolet light, for example). Example wavelengths of suitable light include but are not limited to 355 nm, 385 nm, and 405 nm.

The photohardenable liquid may comprise a mixture of acrylate monomers and oligomers, photoinitiators, colourants and stabilizers such that the mixture polymerizes when exposed to suitable light. Example liquids include Somos NEXT from DSM Somos, USA, and KZ-1860-CL from Allied PhotoPolymers, USA.

Element 101 may possess anti-stick properties in relation to the photohardenable material 104 when it is cured in contact with the sheet. Suitable materials for element 101 include FEP fluoropolymer film manufactured by Du Pont, USA. The film may be of around 125 micrometers thickness, but may be thicker or thinner as appropriate. The sheets are flexible but may not be particularly elastic, having a Young's modulus of around 560 MPa. Generally, but not necessarily, a Young's modulus of between 100 and 1000 MPa may be suitable. Other examples of suitable materials include PFA fluoropolymer film and Teflon AF film, also manufactured by Du Pont. Still other examples of suitable materials are silicone, polyethylene film and cellulose acetate film. Generally, any suitable material may be used for the element 101.

In this embodiment, the element 101 is homogeneous, having a uniform structure and composition throughout. In other embodiments, however, the element 101 may have a multilaminate construction. For example, the sheet may comprise a layer of silicone bonded to a polyester film, the film providing a high Young's modulus and the silicone providing a superior nonstick surface in relation to the photohardenable material 104. Other materials or laminates of different materials may alternatively be used. A face of element 101 may be in contact with the optical diffuser 401 in this but not all embodiments.

The element 101 and side walls 106 form a shallow vessel 108 in the form of a trough or dish for containing the photohardenable liquid 104. The vessel 108 may have a volume sufficient to hold enough photohardenable liquid 104 to build an entire object without being replenished. Optionally, a conduit may connect the vessel and a supply of the photohardenable liquid to replenish the liquid as it is consumed. The element 101 forms the base of the trough 108. The trough 108 and the liquid 104 contained therein is in this but not necessarily in all embodiments removable from the apparatus and replaceable with another trough 108, thus providing a convenient means for replacing damaged troughs or making objects from different materials.

The apparatus has member 301 that supports the element 101. In this embodiment, member 301 supports the element 101 around a perimeter of a transparent plate 201. The underside of the element 101 is optionally biased towards member 301 with spring elements 194,195 which causes the sheet 101 to be tensioned in both the x and y directions.

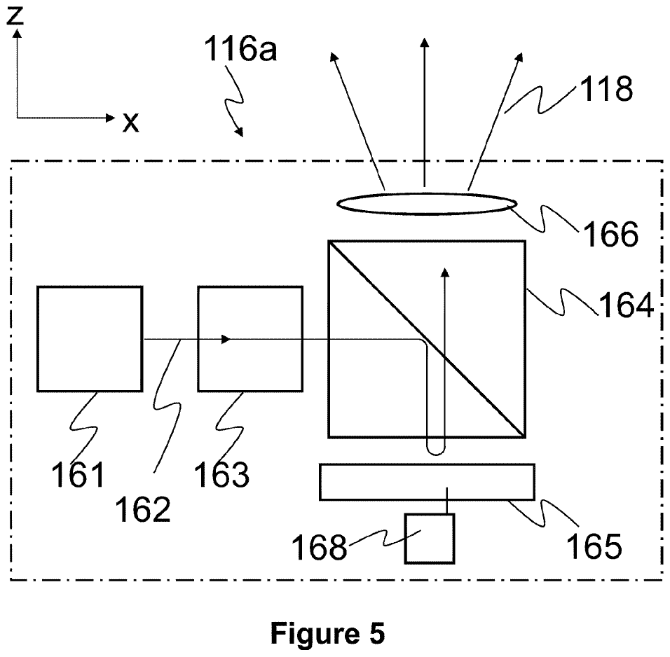

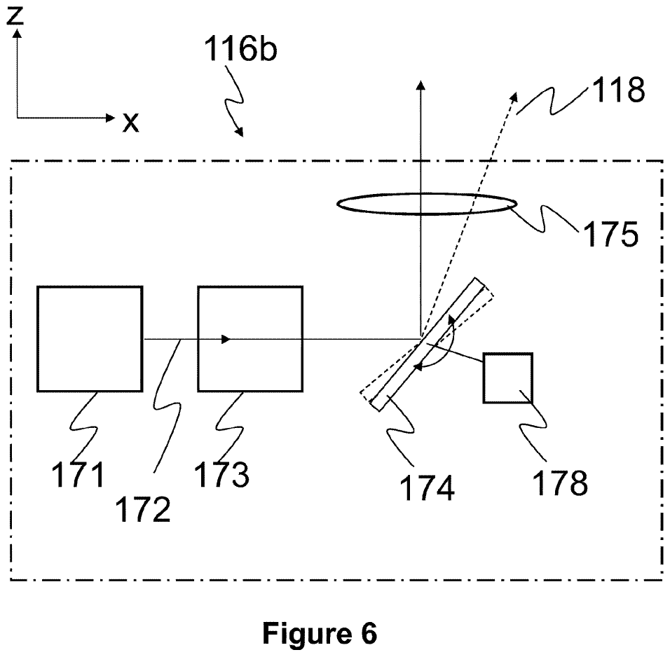

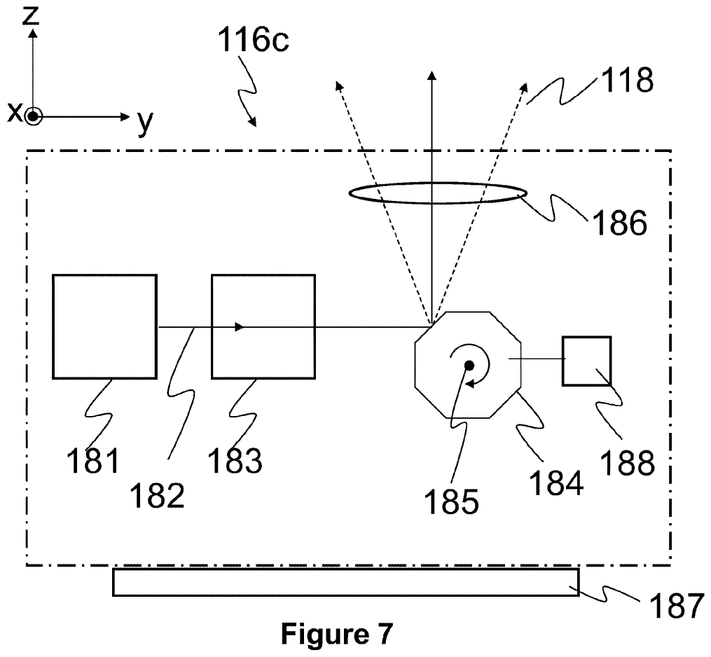

A radiation source in the form of a light source 116 can be activated so that it emits spatially and/or structured light 118 capable of selectively hardening areas of the photohardenable liquid 104 to form a section of the object. Light source 116 may, for example, incorporate a light manipulator such as an image projection system depicted in FIG. 5 and generally indicated with the numeral 116a, comprising light source 161 emitting light 162, relay optics 163, turning prism 164, spatial light modulator 165 controllable by controller 168, and projection lens 166. Alternatively, light source 116 may be a light beam scanning apparatus depicted in FIG. 6 and generally indicated by the numeral 116b, comprising a laser source 171 emitting light 172 of wavelength of around 350 nm, for example, collimating and/or focusing optics 173, scanning mirror 174 whose rotation is controllable in one or more axes by mirror controller 178, optionally a second controllable mirror not shown in the figure, and optionally a projection lens 175 such as an F-Theta lens. Controller 178 can be configured to scan the mirror 174 (coordinated with a second mirror, if present) in a raster scanning mode, or alternatively in a vector scanning mode. FIG. 7 shows a second type of beam scanning apparatus generally indicated by the numeral 116c comprising a laser source 181 emitting light 182, collimating and/or focusing optics 183, polygon mirror 184 rotatable around an axis 185 and controllable by controller 188, and optionally a projection lens 186 such as an F-Theta lens. As the apparatus of 116c may only scan light in the y-axis according to the coordinate system shown in FIG. 7, the apparatus resides on a translation stage 187 which can move the apparatus in the x-direction, enabling the projected light to address locations in the x and y dimensions. The translation stage may comprise any one or more of linear motors, drive belts, stepper motors, rack and pinion arrangements, for example, or generally any suitable components arranged to provide translation. Apparatus 116c is suitable for operating in a raster scanning mode. The light source may, in some embodiments, comprise an incandescent light or light emitting diode, for example. Any suitable light source may be used.

In this but not necessarily in all embodiments, the optical diffuser 401 comprises an optical diffusing film 401 and is translucent (“milky”) to the naked eye. The optical diffusing film 401 comprises polymer in the form of polytetrafluoro-ethylene (PTFE), which is generally translucent due to its crystalline structure. To determine a light diffusion property of the PTFE film, it was placed in the path of a laser beam directed at a screen. The laser beam has the same or an approximately similar wavelength to the hardening light. The light spot formed on the screen was smoothly diffused, without any granularity visible to the naked eye. We call this test the granular free diffusion test. In contrast, when the PTFE was replaced with an etched glass diffuser, the light spot formed on the screen was visibly grainy to the naked eye. Films that can cause granular free diffusion (like the selected PTFE) are likely to be more suitable than films that can cause granular diffusion (like the selected etched glass).

The optical diffusing film 401 has a thickness of 0.05 mm, but in alternative embodiments can have a thickness falling in the one of the ranges of 0.01 mm-1 mm, 0.02 mm to 0.5 mm, 0.04 mm to 0.25 mm, or may have a thickness outside of any of these ranges.

One or more light diffusing properties of the optical diffusing film can be alternatively or additionally determined using Nephelometry or generally any suitable scattering measurement technique, examples of which include but are not necessarily limited to:
ASTM D1003—Standard Test Method for Haze and Luminous Transmittance of Transparent Plastics
BS EN ISO 13468 Parts 1 and 2—Determination of the total luminous transmittance of transparent materials

Different embodiments may have optical diffusers having different light diffusing properties. In these various embodiments, the optical diffuser can be, for example, for:
scattering the material hardening light such that at least one of 1%, 2%, 4%, 8%, 16%, 32% and 64% of the material hardening light is scattered, and/or
scattering the material hardening light such that no more than one of 1%, 2%, 4%, 8%, 16%, 32% and 64% of the material hardening light is scattered.

In these various embodiments, the optical diffuser can be, for example, for:
scattering the material hardening light such that at least one of 1%, 2%, 4%, 8%, 16%, 32% and 64% of the material hardening light is scattered at an angle greater than 2.5 degrees (ASTM D1003—Standard Test Method for Haze and Luminous Transmittance of Transparent Plastics), and/or
the optical diffuser is for scattering the material hardening light such that no more than one of 1%, 2%, 4%, 8%, 16%, 32% and 64% of the material hardening light is scattered at an angle greater than 2.5 degrees (ASTM D1003—Standard Test Method for Haze and Luminous Transmittance of Transparent Plastics).

In these various embodiments, the optical diffuser can be, for example, for:
scattering the material hardening light such that at least one of 1%, 2%, 4%, 8%, 16%, 32% and 64% of the material hardening light is scattered at an angle less than 2.5 degrees (ASTM International standard ASTM D1003-21) and/or
scattering the material hardening light such that no more than at least one of 1%, 2%, 4%, 8%, 16%, 32% and 64% of the material hardening light is scattered at an angle less than 2.5 degrees (ASTM International standard ASTM D1003-21).

Alternative embodiments may generally have any suitable type and arrangement of the optical diffuser 401. For example, the element 101 can be selected to itself diffuse the light and be the optical diffuser. It can comprise suitable PTFE. It can comprise suitable high density polyethylene. A release film can be on the PTFE element 101. The element 101 can be a composite, having a layer of PTFE and a layer of FEP fluoropolymer, each of which are 0.05 mm thick or generally any suitable thickness. The PTFE and FEP layers may not be bonded, but clamped or otherwise held together. The optical diffuser may comprise milky glass, or glass with a textured (for example ground) face. The optical diffuser 401 may be the bottom of the vessel 108, or be within and at the bottom of the vessel 108.

The optical diffuser 401 can alternatively take the form of a switchable optical diffuser. A schematic diagram of an example of an electrically switchable optical diffuser 900 is shown in FIG. 9. The electrically switchable optical diffuser 900 comprises a layer of liquid crystal media 910 enclosed between a plurality of transparent electrical conducting layers 930 and 940. The liquid crystal media 910 is generally, but not necessarily, translucent in its passive state. Applying a voltage potential across the transparent electrical conducting layers 930 and 940 by controlling switch 950 causes the liquid crystal media 910 to reorientate such that the electrical switchable optical diffuser becomes transparent. Examples of such devices are manufactured by: Filmbase Technology Co., Ltd., Shenzhen, China; and ProDisiplay, Barnsley S74 9LH, United Kingdom.

Use of an electrically switchable optical diffuser 900 allows selection of a mode whereby made objects have a relatively more smooth surface, or alternatively, to select another mode whereby made objects have a relatively less smooth surface. It is generally optionally possible to selectively smooth defined surface regions of the fabricated object by performing two separate light exposures per layer of the object. One exposure can be performed with the electrically switchable optical diffuser controlled to be in a diffusing mode to expose one region of the layer, and a second exposure can be performed with the electrically switchable optical diffuser controlled to be in a non-diffusing mode to expose a different region of the same layer. Controller 220 is optionally in electrical communication with electrically switchable optical diffuser 900 to switch the electrically switchable optical diffuser between the mode and the other mode. The electrical communication between the controller 220 and the electrically switchable optical diffuser 900 is shown as a connecting dashed line in FIGS. 1 to 4. The electrical communication generally is not present when the optical diffuser is merely a passive optical diffuser, for example when is a piece of ground glass or PTFE.

The switchable optical diffuser can alternatively comprise a passive diffusing optical element, for example ground glass, FTFE or other type, that is movably mounted for moving into and out of the path of the material hardening light. A motor operationally coupled to the movably mounted passive diffusing optical element can be controlled by controller 220 to move the diffusing optical element. Generally, the switchable optical diffuser can take any suitable and desired form.

Referring again to FIGS. 1 to 4, positioner 120 is capable of linear motion along the z-direction and moves the platform 121 in the form of an inverted platform on which the object being made is mounted. The positioner 120 positions the object being made 122 relative to the upwardly facing surface 102 of the sheet 101. The positioner may comprise any one or more of linear motors, drive belts, stepper motors, rack and pinion arrangements, for example, or generally any suitable components arranged to provide linear motion. Alternatively, or additionally, the positioner may be operationally coupled to the element for changing the distance between the surface 102 and the platform 121.

A sequence of actions can be performed with the apparatus 100 to form a new section of the object 124 and non-destructively separate it from the sheet 101. The process begins as shown in FIG. 1, with the previous sections of the object under fabrication 122 distanced from the sheet 101.

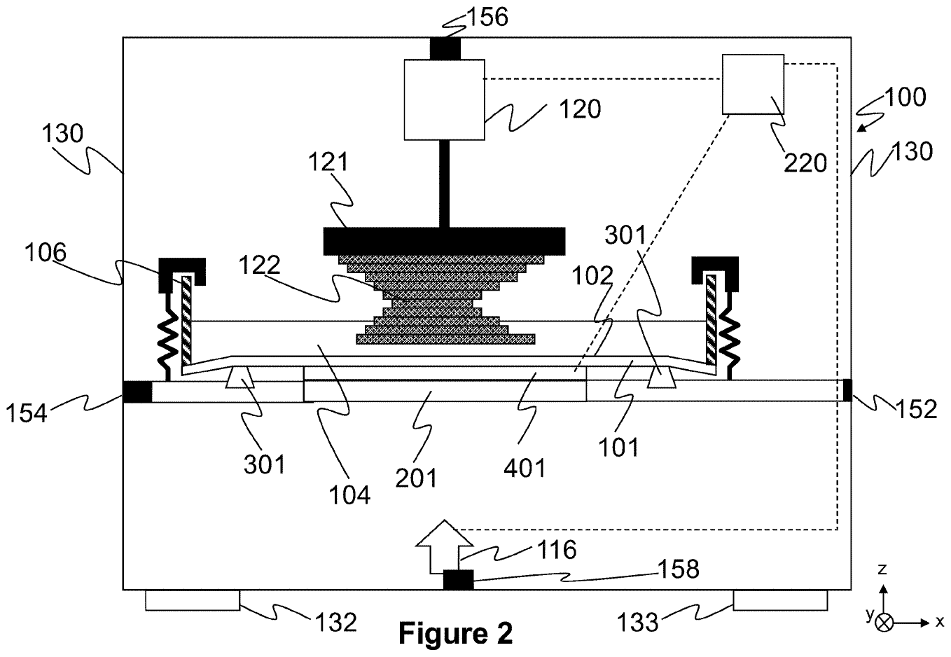

Next, as shown in FIG. 2, positioner 120 lowers the object being made 122 towards the sheet 101. The object 122 comes to a final position which is one section-thickness above the sheet surface 102.

The thickness of one section is typically in the range of 10 micrometers to 250 micrometers, but it may be less if particularly fine fabrication resolution is required, and greater if a relatively coarse fabrication resolution is required.

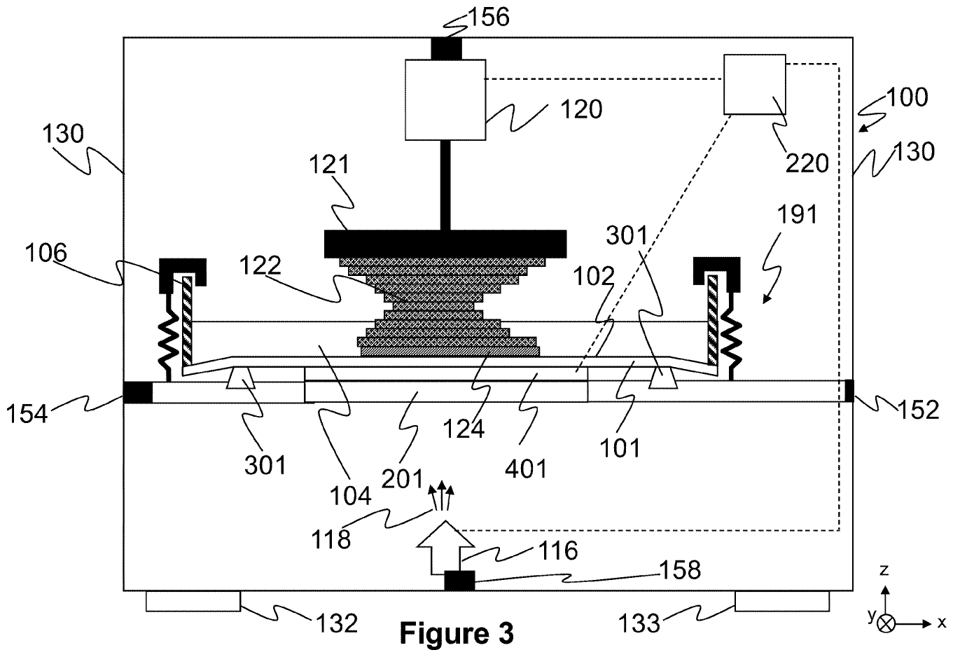

Next, as shown in FIG. 3, light 118 having spatial features in accordance with the sectional geometry of the object being made is emitted from light source 116 to selectively harden regions of the layer of photohardenable liquid 104 in contact with the previously formed sections 122 to form a new hardened section 124.

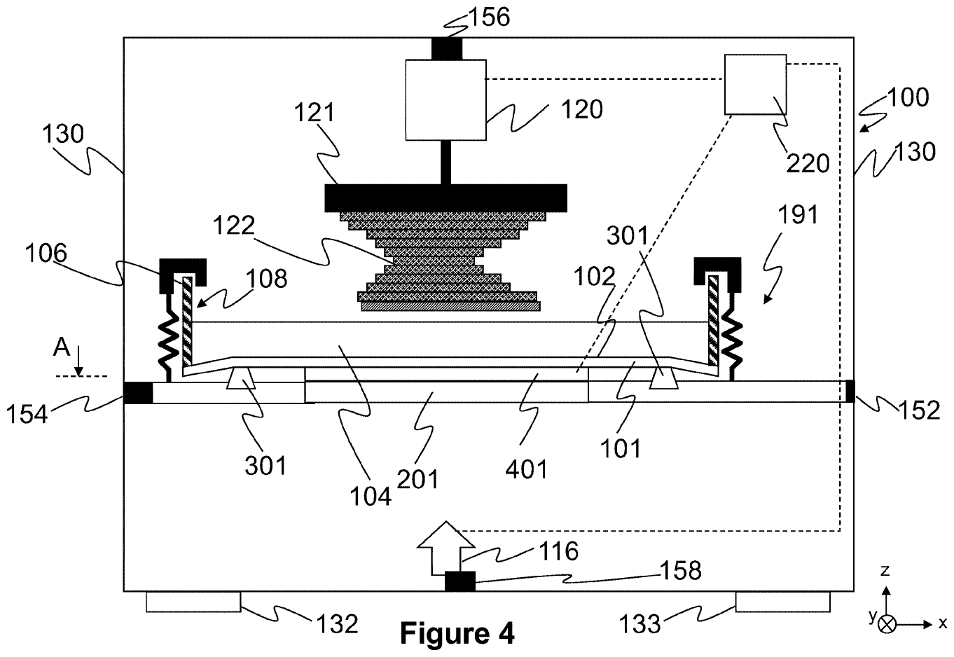

Next, as shown in FIG. 4, positioner 120 is engaged to raise the previously formed sections 122 and newly formed section 124, causing it to be pulled away from the sheet 101. The apparatus 100 is then ready for the process to start again. Repeating this sequence of actions enables a multilaminate object to be fabricated section by section.

Referring back to FIG. 1, an optional window 201 is fabricated of a material transparent to the curing radiation 118 emitted by light source 116. For example, when the curing radiation is 385 nm wavelength light, the window 201 may comprise a 6 mm thick plate of fused silica. The edges of the reference plate 201 may be beveled, or even rounded, to reduce the risk of a scratch or other mark being made. Window 201 shapes the sheet 101 to have it adopt a flat configuration or form while excess photohardenable liquid 104 is forced out of the gap between the previously hardened sections 122 and the sheet 101. Support of the element 101 by the optional window 201 is such that the sheet 101 adopts a flat configuration. A flat section of consistent thickness may subsequently be formed. This may allow for especially flat sections of precise thicknesses to be formed.

The embodiments of FIGS. 1 to 4 are each configured such that in use the sheet 101 is horizontally orientated. The apparatus may, for example, have a chassis 130 with attached feet 132,133 configured to support the chassis 130 above a surface such as a bench, and the sheet 101 is mounted relative to the chassis 130 so that when the chassis 130 is so supported the sheet 101 has a horizontal orientation. In other embodiments, the surface of the sheet 101 which the liquid is disposed on may be inclined at up to 45 degrees to the horizontal (that is, the surface is upwardly facing), provided that the vessel walls 106 are sufficiently high to contain the fluid. Mounting brackets 152,154,156,158 may be used to ensure that apparatus components are maintained in their correct position and orientation relative to the chassis. A mounting platform 510 may serve to mount apparatus components, and is mounted to form a fluid barrier between the upper and lower regions of the apparatus to prevent ingress of any spilled photohardenable fluid 104 which could damage delicate components.

The positioner 120, the light source 116, and optionally other parts of the apparatus may be in communication with and may be controlled by a controller 220 in the form of a processor unit—shown in cenclude a suitable logic device 250 such as, or similar to, the INTEL PENTIUM or a suitably configured field programmable gate array (FPGA), connected over a bus 280 to a random-access memory 240 of around 100 Mb and a non-volatile memory such as a hard disk drive 260 or solid state non-volatile memory having a capacity of around 1 Gb. The processor has input/output interfaces 270 such as a universal serial bus and a possible human machine interface 230 e.g. mouse, keyboard, display etc. Apparatus components may be controlled using commercially available machine-to-machine interfaces such as LABVIEW software together with associated hardware recommended by the commercial interface provider installed on the processor unit 220, over USB or RS-232 or TCP/IP links, for example. Alternatively, custom driver software may be written for improved performance together with custom printed circuit boards. Alternatively, the processor unit 220 may comprise an embedded system.

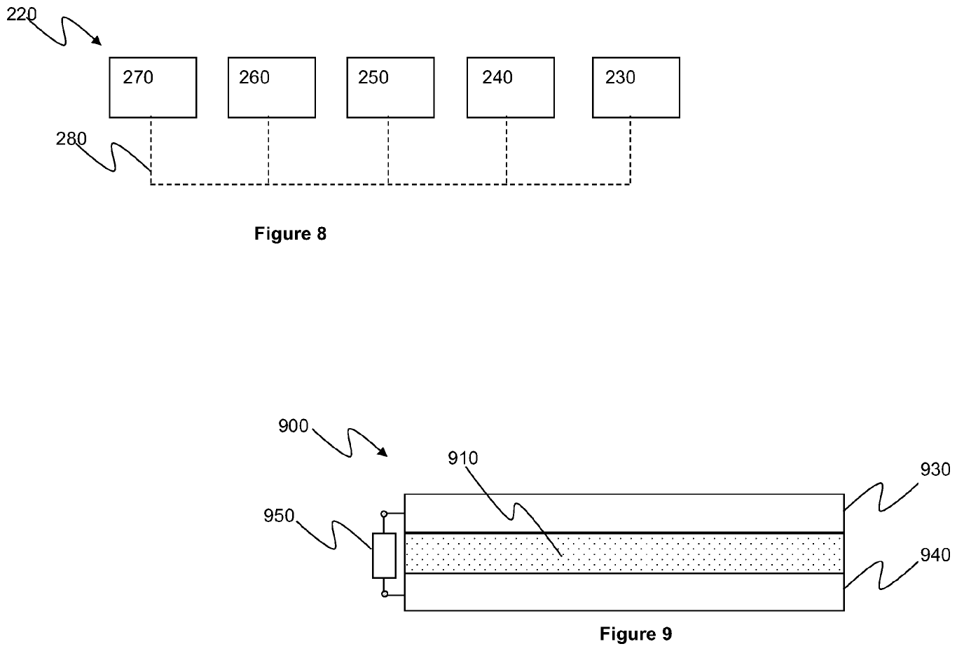

In this embodiment, the controller 220 is in communication with another processor which is adapted for determining instructions and/or information for the apparatus. In alternative embodiments, the processors are the same processor. An example of another processing unit comprises a logic device such as, or similar to, the INTEL PENTIUM or a suitably configured field programmable gate array (FPGA), connected over a bus to a random-access memory of around 100 Mb and a non-volatile memory such as a hard disk drive or solid-state non-volatile memory having a capacity of around 1 Gb. Generally, the configuration may be similar or identical to that shown in FIG. 8. The processor has a receiver such as a USB port (or Internet connection, for example) for receiving information representing a solid object, stored on a USB FLASH device, for example. The information may be encoded in a file generated by a Computer Aided Design (CAD) program, the information specifying the geometry of the object. The processor runs a decomposer program implementing an algorithm that decomposes (or transforms) the information into data indicative of a plurality of sections to be formed sequentially by the apparatus, the material being used to make the solid object. The program may have been installed onto the processor from tangible media such as a DVD or USB memory stick, for example, that stored the program. In an alternative embodiment, the decomposer may be a dedicated hardware unit. A series of sections through the object are determined, each section corresponding to a solid section to be formed. The sections may then be further processed to represent the geometry of each section as a rasterized bitmap. The sections or bitmaps may then be used to control the apparatus.

Embodiments described herein may be used to make a stereolithographic object of generally any shape or size, including jewelry such as rings, prototype car components, micro-components for precision machines, models for investment casting, rapid prototypes, dental models, hearing aids, models of anatomical and other objects, circuit boards and architectural or design features for a building. The stereolithographic object may, for example, be rigid or resilient. It may have one or more hollows or voids, such as that of a cup or tennis ball, for example.

Now that embodiments of the invention have been described, it will be appreciated that some embodiments may have some of the following advantages:
Smoother stereolithographic objects may be fabricated, examples of which may include but are not limited to lenses and hearing aids.

It will be appreciated that numerous variations and/or modifications may be made to the invention as shown in the specific embodiments without departing from the spirit or scope of the invention as broadly described. For example:

The optical diffuser may comprise generally any suitable material, and may comprise:
polymers encapsulating scattering centers in the form of a pigment or other suitable particles. For example, pigmented fluorinated ethylene propylene (FEP), pigmented perfluoroalkoxy (PFA), pigmented polyethylene terephthalate (Mylar™) and pigmented polyethylene.
an imprinted, patterned or etched substrate comprising glass and/or a polymer. The imprint or pattern may be a diffractive optical structure which diffuses incident light.
crystalline or semi-crystalline polymers, examples of which include but are not limited to polytetrafluoro-ethylene (PTFE), semi-crystalline high-density polyethylene and semi-crystalline polypropylene.
translucent “milky” glass such as lithium disilicate or ceramic such as aluminum oxide or zirconium oxide.
clear glass such as fused silica or borosilicate glass containing scattering centers in the form of pigment or other particles.
   The flexible element may not be flat like a sheet, but rather may be wedged.
   The downwardly facing surface of the element may be textured.
   The upward facing surface of the window may be textured.

The present embodiments are, therefore, to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. An apparatus for making a stereolithographic object, the apparatus comprising:
a surface for disposing thereon a material used to make a stereolithographic object;
a platform for making the stereolithographic object thereon;
a light source configured to generate a material hardening light for hardening the material; and
an optical diffuser for diffusing the material hardening light, the optical diffuser being optically intermediate the light source and the surface.

2. The apparatus defined by claim 1, wherein the optical diffuser comprises an optical diffusing film.

3. The apparatus defined by claim 1, wherein the optical diffuser comprises a polymer.

4. The apparatus defined by claim 3, wherein the optical diffuser comprises at least one of a crystalline polymer and a semi-crystalline polymer.

5. The apparatus defined by claim 4, wherein the polymer comprises polytetrafluoroethylene (PTFE).

6. The apparatus defined by claim 4, wherein the polymer comprises one of semi-crystalline polyethylene and semi-crystalline polypropylene.

7. The apparatus defined by claim 1, wherein the optical diffuser comprises a ceramic.

8. The apparatus defined by claim 1, wherein the optical diffuser comprises a glass.

9. The apparatus defined by claim 1, wherein the optical diffuser comprises a plurality of selectable modes comprising a light diffusing mode and a light non-diffusing mode.

10. The apparatus defined by claim 9, wherein the plurality of modes are electrically selectable.

11. The apparatus defined by claim 1, comprising an element comprising the surface and the optical diffuser.

12. The apparatus defined by claim 11, wherein the element comprises a composite sheet comprising the surface and the optical diffuser.

13. The apparatus defined by claim 1, wherein the optical diffuser is translucent.

14-23. (canceled)

24. The apparatus defined by claim 1, wherein the optical diffuser is for generating a granular free optical diffusion.

25. The apparatus defined by claim 1, comprising a positioner operably coupled to at least one of the platform and the surface and operable to change a distance between the platform and the surface.

26. A method for making a stereolithographic object, the method comprising the steps of:
generating a material hardening light;
diffusing the material hardening light to generate a diffused material hardening light; and
illuminating material used to make a stereolithographic object with the diffused material hardening light.

27. The method defined by claim 26, comprising illuminating the material used to make the stereolithographic object with material hardening light that has not been diffused.

28. The method defined by claim 26, performed with an apparatus for making the stereolithographic object, the apparatus comprising:
a surface for disposing thereon the material used to make the stereolithographic object;
a platform for making the stereolithographic object thereon;
a light source configured to generate the material hardening light for hardening the material; and
an optical diffuser for diffusing the material hardening light, the optical diffuser being optically intermediate the light source and the surface.

29. A method for making a stereolithographic object, the method comprising the steps of:
generating a material hardening light;
switching between a light diffusing mode and a light non-diffusing mode of a light diffuser having a plurality of modes;
illuminating a material used to make a stereolithographic object with the material hardening light that has propagated through the light diffuser.

30. The method defined by claim 29, wherein illuminating a material comprises illuminating a layer of the material with the material hardening light that has propagated through the light diffuser while in one of the light diffusing mode and the light non-diffusing mode, and subsequently illuminating the layer of the material with the material hardening light that has propagated through the light diffuser while in the other one of the light diffusing mode and the light non-diffusing mode.

31-32. (canceled)
